(19) United States
(12) Patent Application Publication
(10) Pub. No.: US 2012/0234636 A1
(43) Pub. Date: Sep. 20, 2012

(54) Balance bike brake

(76) Inventor: Ryan McFarland, Rapid City, SD (US)

(21) Appl. No.: 13/065,188

(22) Filed: Mar. 15, 2011

(51) Int. Cl. B62L 1/04

(52) U.S. Cl. 188/74

(57) ABSTRACT

A balance bike brake is disclosed which may be affixed to a balance bike and provides a brake which may be operated by the rider's foot.

### BACKGROUND OF THE INVENTION

1. Field of the Invention

The present invention relates generally to balance bikes and more specifically to a wheel surface brake for a balance bike.

2. Background Information

Bicycles have had brakes for over a hundred years. For many years, coaster brakes were standard on almost all bicycles. Although many bikes still have coaster brakes, most bicycles have some form of hand brake with brake levers mounted to the handle bars. A balance bike is similar to a small bicycle for use by young children, but it has no pedals. It is also sometimes referred to as a running bike or push bike. Although the concept of the balance bike has been around for well over a hundred years, the use of balance bikes by young children is a relatively recent phenomenon. Several balance bikes are sold with hand brakes.

In the early years of bicycles several foot powered brakes were invented. The patent to Porter (U.S. Pat. No. 529,627; Nov. 20, 1894) discloses a brake which is mounted on the front fork just above the front tire. The brake is a metal strip which extends from the front fork back toward the rider. The rider may push down on the strip with a foot which causes the strip to engage the surface of the tire. Another foot powered brake is disclosed in the patent to Goldman (U.S. Pat. No. 613,508; Nov. 1, 1898). This device provides a bracket which is affixed to the frame member between the crank and the front fork. A long lever is pivotally affixed to the bracket. The lever extends from near the front wheel at one end to near the rear wheel on the other end. When the portion of the lever near the front wheel is pressed by the rider's foot, the other end presses against the rear wheel and slows the bicycle. As may be seen, this type of brake could prove dangerous if, for example, a rider's foot interferes with the operation of the front wheel while attempting to brake.

The devices disclosed in the above patents and others having a similar configuration are all designed to work in a manner which allows them to be operated by a foot while not interfering with the crank and pedals on the bike. This requires that a rider's foot move from the ordinary position on the pedals to an unnatural position near the top of the front fork to operate the brake. Movement such as this is obviously awkward and potentially dangerous. Several versions of this type of brake operate on the front wheel rather than the back wheel. Any foot brake which requires a rider to move a foot from the usual position beneath the rider to some other position is potentially dangerous because it unbalances the rider and requires movement which is significantly different from movement associated with ordinary operation of the bike. The rider not only must move a part of the body to a position which is unusual and awkward, but must concentrate on something other than riding and steering when using such a brake.

The balance bike brake of the instant invention solves the above problems by providing a foot brake for a balance bike which allows a rider to operate the brake without moving the foot appreciably from the ordinary riding position. The ideal invention should also be simple, reliable, inexpensive, and easy to operate and maintain.

### SUMMARY OF THE INVENTION

The balance bike brake of the instant invention is intended to be used with a balance bike. The brake includes a pivot bracket which is affixed to the balance bike just forward of the forwardmost surface of the rear wheel. The brake lever is pivotally affixed to the pivot bracket such that when the forward portion of the brake lever is pressed downward, the rearward portion of the brake lever is forced against the surface of the rear tire which slows the balance bike. A spring is provided which tends to force the rearward portion of the brake lever away from the rear tire.

One of the major objects of the present invention is to provide a foot brake for a balance bike which allows a rider to operate the brake without moving the foot appreciably from the ordinary riding position.

Another objective of the present invention is to provide a balance bike brake which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a side view of the brake lever portion of the instant invention;

FIG. 2 is a rear view of the brake lever portion of the instant invention;

FIG. 3 is a top view of the brake lever portion of the instant invention;

FIG. 4 is a side view of the spring portion of the instant invention;

FIG. 5 is a side view of the instant invention installed on a balance bike; and

FIG. 6 is a partial bottom view of the instant invention installed on a balance bike.

### DESCRIPTION OF A PREFERRED EMBODIMENT

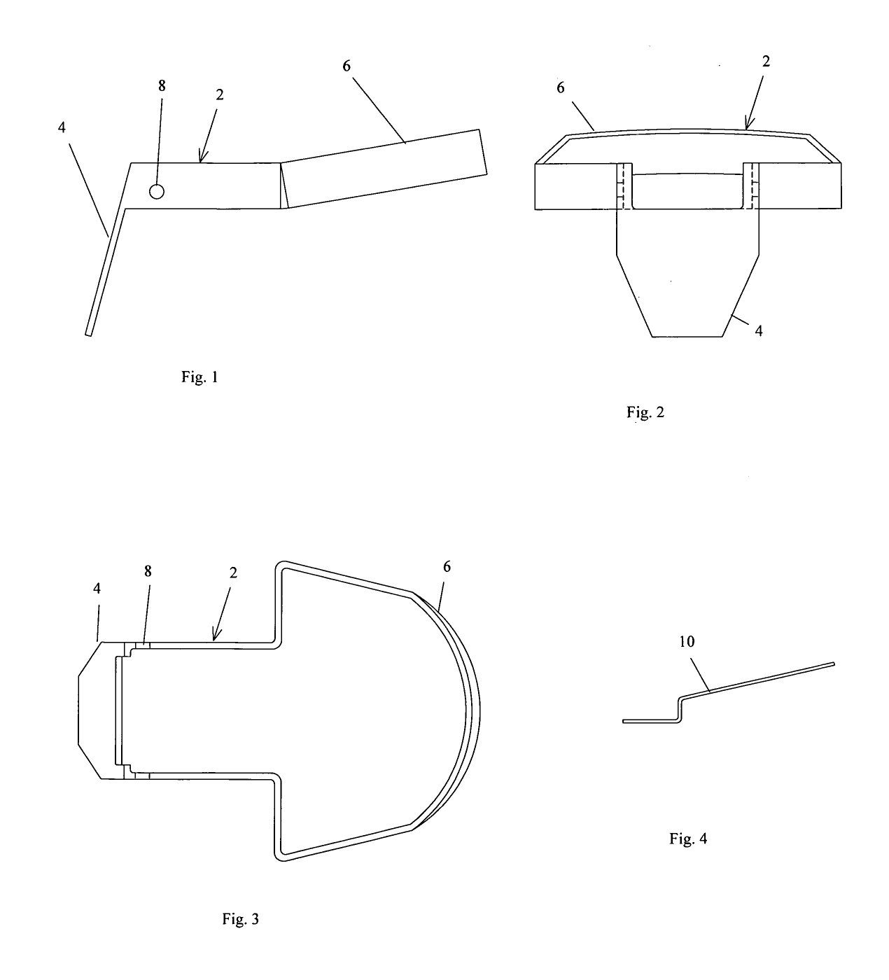

Referring to the drawings, FIGS. 1 through 6, there are shown various views of the instant invention. Because the instant invention is made to be affixed to a balance bike just forward of the rear wheel, the balance bike brake would most likely not work on a pedal bicycle which has a crank and pedals. That is, where traditional bicycle brakes had to be situated such that they did not interfere with the operation of pedals and cranks, a balance bike has no pedals or cranks. The instant invention is, therefore, intended to be used on a balance bike which has no pedals.

Now referring to FIG. 1, a side view of the brake lever portion of the instant invention is shown. The brake lever 2 has a brake pad 4 at its rearward end and a foot pad 6 at its forward end. The brake lever 2 has the general shape of an “L” with the brake pad 4 being the shorter leg of the “L.” There is a pivot hole 8 through said brake lever 2 at a point between said brake pad 4 and the foot pad 6.

Referring now to FIG. 2, a rear view of the brake lever portion of the instant invention is shown. This view generally shows that said foot pad 6 is wider than said brake pad 4 and that the interior of said brake lever 2 is open. Said foot pad 6 is wider than the sides of the frame of the balance bike such that it protrudes outward beyond the frame of the balance bike. Said brake pad 4 is generally about the same width as the rear wheel of the balance bike.

Referring now to FIG. 3, a top view of the brake lever portion of the instant invention is shown. This view shows that the forward portion of said brake lever 2 is significantly wider than the rearward portion of said brake lever 2. The pivot hole 8 passes through both sides of said brake lever 2 and is generally perpendicular to the plane of the balance bike.

Referring now to FIG. 4, a side view of the spring portion of the instant invention is shown. The spring 10 in this embodiment is a strip of spring steel which has the general shape of a squared off “S.”

Referring now to FIG. 5, a side view of the balance bike brake of the instant invention installed on a balance bike is shown. There is a frame hole 12 through the frame 14 just forward of the forward portion of the rear wheel 16. A bolt 18 passes through said pivot hole 8 and the frame hole 12 and affixes said brake lever 2 to the frame 14. Said brake lever 2 may pivot about the bolt 18. The rearwardmost end of spring 10 engages the top of said brake pad 4. The bend in the middle of said spring 10 engages the forward and bottom surface of said bolt 18 which tends to keep said spring 10 in the appropriate position. A seat tube 20 passes through said frame 14 and holds a seat post 22. The forward end of said spring 10 engages the seat tube 20 at a point forward of and above said bolt 18. When said spring 10 engages said seat tube 20 and the top of said brake pad 4, said spring 10 is in tension and tends to rotate said brake pad 4 in the direction indicated by arrow A. The rider may press down on said foot pad 6 which tends to overcome said spring 10 and to force said foot pad 6 in the direction indicated by arrow B. This causes said brake pad 4 to press against the rear wheel 16 and slows the balance bike.

Still referring to FIG. 5, a foot 40 is shown which, of course, is not considered a part of the invention. This Figure shows the unique manner in which a rider may operate the balance bike brake of the instant invention by rotating the foot 40 from the usual riding position which is parallel to the ground to the braking position as indicated by the position of said foot 40. As shown in this Figure, the balance bike brake of the instant invention may be easily operated without requiring a rider to move the foot appreciably from the ordinary riding position. Said foot 40 is simply rotated from the parallel riding position to the position indicated in this Figure.

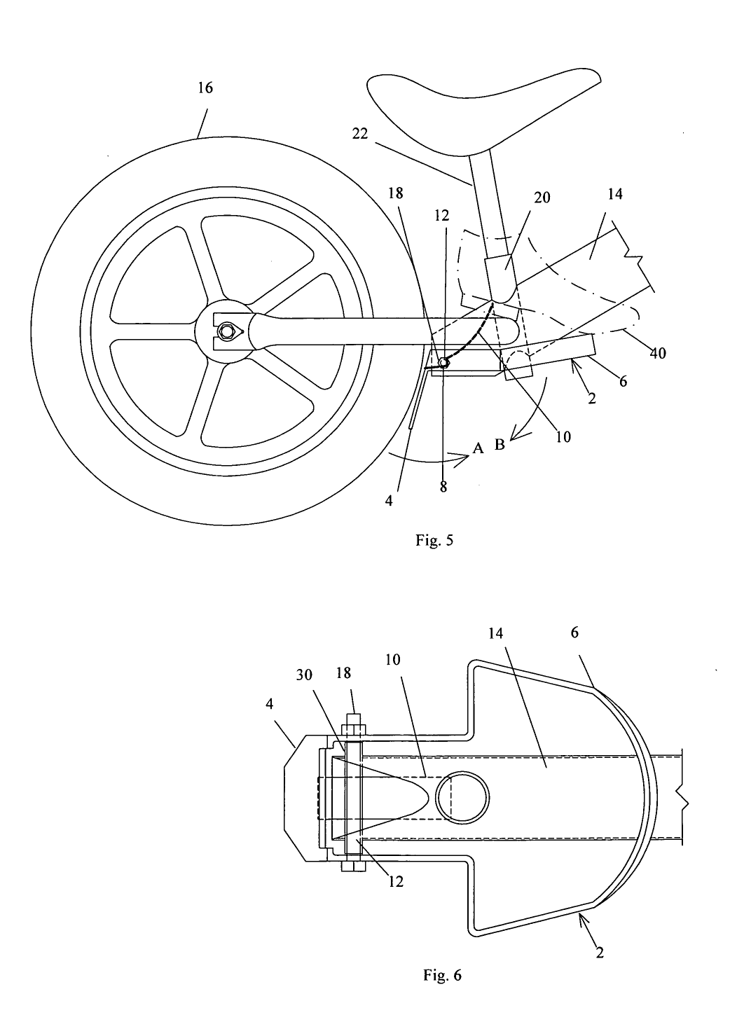

Referring now to FIG. 6, a partial bottom view of the balance bike brake of the instant invention installed on a balance bike is shown. This view shows that said foot pad 6 is significantly wider than said frame 14. The rearward portion of said brake lever 2 is slightly wider than said frame 14. In this embodiment, a bolt tube 30 passes through the frame hole 12 and extends outward such that it just fits within the rearward portion of said brake lever 2. In this embodiment, said bolt 18 passes through said bolt tube 30. In the embodiment with said bolt tube 30, the bend in said spring 10 engages the forward and bottom surface of said bolt tube 30 rather than said bolt 18 as described above. This view shows that the longitudinal axis of said spring 10 is roughly parallel with the vertical plane of said frame 14 of the balance bike. It will be understood that said spring 10 could be replaced by a variety of other spring means provided that they tend to force said brake pad 4 away from said rear wheel 16.

The instant invention will work without the addition of said bolt tube 30, but said bolt tube 30 allows said brake lever 2 to rotate freely. Because said foot pad 6 is located forward of said rear wheel 16 and beneath said seat post 22, it is located near the usual position of a rider's feet and may be operated without distracting the rider by forcing the feet into a position very different from the usual operating position.

In the preferred embodiment all element of the instant invention are made from steel, but other materials having about the same strength, rigidity, and weather resistance could be used.

While preferred embodiments of this invention have been shown and described above, it will be apparent to those skilled in the art that various modifications may be made in these embodiments without departing from the spirit of the present invention. That is, the method could be used for a wide variety of purposes either in combination or separately.

We claim:

1. A balance bike brake for use with a balance bike with no pedals in which the steerable wheel is in the front of the balance bike and the balance bike has a frame member which is forward of a rear wheel comprising:
(1) a brake member having a forward end and a rearward end which is capable of being rotatably affixed to the frame member of the balance bike at a position between the forward end and the rearward end of the brake member such that said brake member rotates in the vertical plane of the balance bike and in which an operator may engage the forward end of said brake member with the operator's foot without moving the foot appreciably from the usual operating position of the foot and in which, when the operator presses down on the forward end of said brake member, the rearward end of said brake member engages the rear tire of the balance bike and tends to slow the balance bike.

2. The balance bike brake of claim 1 in which a spring is inserted between said brake member and said frame member such that the spring tends to force the rearward end of said brake member away from the rear wheel of the balance bike.

3. A balance bike brake for use with a balance bike with no pedals in which the steerable wheel is in the front of the balance bike and the balance bike has a frame member which is forward of a rear wheel comprising:
(1) a brake member having a forward end and a rearward end which is capable of being rotatably affixed to the frame member of the balance bike at a position between the forward end and the rearward end of the brake member and beneath the center of the body of an operator such that said brake member rotates in the vertical plane of the balance bike and in which an operator may engage the forward end of said brake member with the operator's foot by rotating the operator's foot without moving the foot laterally from the usual operating position of the foot and in which, when the operator presses down on the forward end of said brake member, the rearward end of said brake member engages the rear tire of the balance bike and tends to slow the balance bike.

4. The balance bike brake of claim 3 in which a spring is inserted between said brake member and said frame member such that the spring tends to force the rearward end of said brake member away from the rear wheel of the balance bike.
